(19) United States
(12) Patent Application Publication
(10) Pub. No.: US 2005/0096215 A1
(43) Pub. Date: May 5, 2005

(54) Process for producing synthesis gas using stabilized composite catalyst

(75) Inventors: Rafael L. Espinoza, Ponca City, OK (US); Harold A. Wright, Ponca City, OK (US); Tianyan Niu, Ponca City, OK (US); Kandaswamy Jothimurugesan, Ponca City, OK (US)

Correspondence Address: DAVID W. WESTPHAL;CONOCOPHILLIPS COMPANY - I.P. Legal, P.O. BOX 1267, PONONCA CITY, OK, 74602-1267, US

(73) Assignee: ConocoPhillips Company, Houston, TX (US)

(21) Appl. No.: 10/699,018

(22) Filed: Oct. 31, 2003

(51) Int. Cl. B01J 21/18; C01B 3/32; B01J 21/08; B01J 21/12

(52) U.S. Cl. 502/302; 502/240; 502/325; 502/304; 423/651; 423/418.2

(57) ABSTRACT

A catalytic partial oxidation process for producing synthesis gas is disclosed which comprises passing a light hydrocarbon and oxygen mixture over a composite catalyst to produce a mixture of carbon monoxide and hydrogen. Preferred composite catalysts are prepared by mixing together discrete particles of catalytic metal and of promoter. The resulting catalyst resists deactivation due to reaction between the active metal and the promoter. A catalyst and method for making a catalyst and a method for making middle distillates from light hydrocarbons are also disclosed.

### BACKGROUND OF THE INVENTION

1. Technical Field of the Invention

The present invention generally relates to catalysts and processes for the catalytic partial oxidation of light hydrocarbons (e.g., methane, or a mixture of C₁-C₅ hydrocarbons) to produce a product mixture comprising CO and H₂ (synthesis gas, or syngas). More particularly, the invention pertains to such processes and catalysts in which the active metal and the promoter are stabilized in a composite structure.

2. Description of Related Art

Many refineries face an abundant supply of lower alkanes-i.e., C₁-C₅ alkanes such as methane and relatively few means of converting them to more valuable products. Moreover, vast reserves of methane, the main component of natural gas, are available in many areas of the world, and natural gas is predicted to outlast oil reserves by a significant margin. There is great incentive to exploit these natural gas formations; however, most natural gas formations are situated in areas that are geographically remote from population and industrial centers. The costs of compression, transportation, and storage make its use economically unattractive. To improve the economics of natural gas use, much research has focused on methane as a starting material for the production of higher hydrocarbons and hydrocarbon liquids, which are more easily transported than syngas.

The conversion of methane to higher hydrocarbons is typically carried out in two steps. In the first step, methane is reformed with water to produce a mixture of carbon monoxide and hydrogen (referred to as “synthesis gas” or “syngas”). In a second step, the syngas is converted to higher hydrocarbons, for example, using the Fischer-Tropsch process to provide fuels that boil in the middle distillate range, such as kerosene and diesel fuel, and hydrocarbon waxes. Current industrial use of methane as a chemical feedstock proceeds by the initial conversion of methane to carbon monoxide and hydrogen by either steam reforming, which is the most widespread process, or by dry reforming or autothermal reforming. Steam reforming currently is the major process used commercially for the conversion of methane to synthesis gas, proceeding according to Equation 1.
CH₄+H₂O→CO+3H₂ (1)
For many industrial applications, the 3:1 ratio of H₂:CO products is problematic, and the typically large steam reforming plants are not practical to set up at remote sites of natural gas formations.

Methane residence times in steam reforming are typically on the order of 0.5-1 second, whereas for heterogeneously catalyzed partial oxidation, the residence time is on the order of a few milliseconds. Thus, for the same production capacity, syngas facilities for the partial oxidation of methane can be far smaller and less expensive than facilities based on steam reforming. A recent report (M. Fichtner et al. Ind. Eng. Chem. Res. (2001) 40:3475-3483) states that for efficient syngas production, the use of elevated operating pressures of about 2.5 MPa is required. Those authors describe a partial oxidation process in which the exothermic complete oxidation of methane is coupled with the subsequent endothermic reforming reactions (water and CO₂ decomposition). This type of process can also be referred to as autothermal reforming or ATR, especially when steam is co-fed with methane. Certain microstructured rhodium honeycomb catalysts are employed which have the advantage of a smaller pressure drop than beds or porous solids (foams) and which resist the reaction heat of the total oxidation reaction taking place at the catalyst inlet.

The catalytic partial oxidation (CPOX) or direct partial oxidation of hydrocarbons (e.g., natural gas or methane) to syngas has also been described in the literature. In catalytic partial oxidation, natural gas is mixed with air, oxygen-enriched air, or oxygen and introduced to a catalyst at elevated temperature and pressure. The partial oxidation of methane yields a syngas mixture with a H₂:CO ratio of 2:1, as shown in Equation 2.
CH₄+½O₂ΠCO+2H₂ (2)
This H₂:CO ratio is more useful than the ratio from steam reforming for the downstream conversion of the syngas to chemicals such as methanol and to fuels. The CPOX reaction is exothermic, while the steam reforming reaction is strongly endothermic. Furthermore, oxidation reactions are typically much faster than reforming reactions. This allows the use of much smaller reactors for catalytic partial oxidation processes than is possible in a conventional steam reforming process.

While its use is currently limited as an industrial process, the direct partial oxidation or CPOX of methane has recently attracted much attention due to its inherent advantages, such as the fact that due to the significant heat that is released during the process, there is no requirement for the continuous input of heat in order to maintain the reaction, in contrast to steam reforming processes. An attempt to overcome some of the disadvantages and costs typical of steam reforming by production of synthesis gas via the catalytic partial oxidation of methane is described in European Patent No. 303,438 (Davy McKee Corporation). According to that method, certain monolith catalysts are used, with or without metal addition to the surface of the monolith, and the process operates at space velocities of 20,000-500,000 hr⁻¹. Certain high surface area monoliths of cordierite (MgO/Al₂03/SiO₂), Mn/MgO cordierite (Mn—MgO/Al₂O₃/SiO₂), mullite (Al₂O₃/SiO₂), mullite aluminum titanate (Al₂O₃/SiO₂—(Al,Fe)₂O₃/TiO₂), zirconia spinel (ZrO₂/MgO/Al₂O₃), spinel (MgO/Al₂O₃), alumina (Al₂O₃) and high nickel alloys are suggested as catalysts for the process. The monoliths may be coated with metals or metal oxides that have activity as oxidation catalysts—e.g., Pd, Pt, Rh, Ir, Os, Ru, Ni, Cr, Co, Ce, La, and mixtures thereof. Other suggested coating metals are noble metals and metals of groups IA, IIA, III, IV, VB, VIB, or VIIB of the periodic table of the elements. The exemplary reaction is catalyzed by a monolith of Pt—Pd on an alumina/cordierite support. Catalyst disks of dense wire mesh, such as high temperature alloys or platinum mesh are also described. Optionally, the wire mesh may be coated with certain metals or metal oxides having catalytic activity for the oxidation reaction.

Other catalytic partial oxidation processes have been described, for example, in U.S. Pat. No. 5,654,491 (Regents of the University of Minnesota) and U.S. Pat. No. 6,402,989 (Conoco Inc) and in J. Catalysis 138, 267-282 (1992). Although in many short contact time syngas generation systems the syngas reaction can be self-sustaining once initiated, it has been shown that 10-15% of the carbon initially present as methane can be lost to the formation of CO₂ due to combustion. This directly reduces the yield of syngas that can be obtained. Therefore, it is desirable to use a syngas generation system that allows a better yield of carbon monoxide and hydrogen.

The selectivities of catalytic partial oxidation to the desired products, carbon monoxide and hydrogen, are controlled by several factors, but one of the most important of these factors is the choice of catalyst composition. The noble metals that typically serve as the best catalysts for the partial oxidation of methane are scarce and expensive. The large volumes of catalyst needed by most catalytic partial oxidation processes have placed these processes generally outside the limits of economic justification for industrial scale commercial applications. The less expensive catalytic metals have the disadvantage of promoting coke formation on the catalyst during the reaction, which results in loss of catalytic activity. Moreover, in order to obtain acceptable levels of conversion of gaseous hydrocarbon feedstock to CO and H₂ it is typically necessary to operate the reactor at a relatively low flow rate, or space velocity, using a large quantity of catalyst.

For successful operation at commercial scale, the catalytic partial oxidation process must be able to achieve a high conversion of the methane feedstock at high gas hourly space velocities, and the selectivity of the process to the desired carbon monoxide and hydrogen products must also be high. Such high gas hourly space velocities are difficult to achieve and maintain at reasonable gas pressure drops, particularly with fixed beds of catalyst particles. Also, high conversion and selectivity must be achieved without detrimental effects to the catalyst, such as the formation of carbon deposits on the catalyst (coking) that severely reduce catalyst performance. Not only is the choice of the catalyst's chemical composition important, the physical form of the catalyst and its support structure must possess mechanical strength and porosity in order to function under operating conditions of high pressure and high flow rate of the reactant and product gasses. The partial oxidation of methane is an exothermic reaction, and temperatures in excess of 1,000° C. may be required for successful operation. It is known that ceramic monolith catalyst supports are susceptible to thermal shock-i.e., either rapid changes in temperature with time or substantial thermal gradients across the catalyst structure. Catalysts and catalyst supports for use in such a process must therefore be very robust and avoid structural and chemical breakdown under the relatively extreme conditions prevailing in the reaction zone. There are continuing efforts in this field to develop stronger, more porous catalyst supports.

U.S. Patent Application Publication No. 2002/0035036 A1 (Conoco Inc.) describes the production of synthesis gas using a NiO—MgO coated porous bulk metal alloy substrate and an active metal catalyst outer layer. The NiO—MgO coating, which itself has catalytic activity, also functions as a diffusion barrier to the supported metal catalyst, preventing alloying of the catalyst metal with the catalyst support. The new catalysts are also better able to resist thermal shock than conventional catalysts and offer a more economic alternative to using large amounts of expensive metal catalysts.

U.S. Pat. No. 5,648,582 (Regents of the University of Minnesota) discloses a rhodium or platinum catalyst prepared by washcoating an alumina foam monolith having an open, cellular, sponge-like structure. The catalyst is used for the catalytic partial oxidation of methane at space velocities of 120,000 h⁻¹ to 12,000,000 h⁻¹.

A problem that is frequently encountered with catalyst supports is the loss of availability of the active metal due to chemical reaction of the catalytic metal and/or promoters with the support. Sometimes a portion of the precious metal forms an alloy or solid solution with the support material. This type of solid reaction typically takes place at the very high reaction temperatures that are usual in syngas reactors. For example, in the case of rhodium, typically as much as 20% may be lost to an alumina support.

Sintering and solid reactions that take place in syngas catalysts are prevalent deactivation mechanisms. Sintering causes loss of desirable high surface area and results in fewer available catalytic sites. The very high reaction temperature seen by a catalyst at typical syngas reactor conditions also favors the occurrence of solid reactions between the active metal and the support and/or between the promoter and the support, as described in co-owned provisional U.S. Patent Application No. 60/425,383, which is incorporated herein by reference in its entirety. A less known problem, however, is that the same syngas reactor conditions also bring about alloying or solid reactions between the active metal and the promoter. Efforts aimed at reducing catalyst loss by treating the catalyst support material are typically ineffective at minimizing reactions between the active metal and promoters.

U.S. Patent Publication No. U.S.-2002-0012624-A1 describes certain self-supporting bulk nickel alloy syngas catalysts (e.g., Ni—Rh, Ni—Cr, and Ni—Co—Cr) that retain a high level of activity and selectivity to carbon monoxide and hydrogen products under conditions of high gas space velocity, elevated pressure, and high temperature. Other Ni-alloying metals include Mn, Mo, W, Sb, Re, K, Bi, Fe, V, and Cu.

Notwithstanding the advances that have been made in deterring loss of catalytic metal and promoters through sintering and/or solid reaction with various support materials, there remains a need for supported catalysts that avoid deactivation due to the occurrence of undesirable solid reactions between the active metal and promoters that are caused by exposure to the high temperatures that prevail at CPOX reactor operating conditions. Catalyst instability due to sintering of the active metal and promoter and/or loss of the catalytic metals and/or promoters due to solid reaction between the two components contributes to catalyst cost. Increased catalyst costs are reflected in higher processing costs for producing synthesis gas. A way of overcoming these catalyst problems is needed so that production of synthesis gas at high space velocity yields via a catalytic partial oxidation process is practical for commercial industrial-scale applications.

### SUMMARY OF PREFERRED EMBODIMENTS

The present invention provides a catalyst for catalyzing the partial oxidation of light hydrocarbons to form a synthesis gas (CO and H₂). The catalyst comprises a first and a second population of catalyst support particles. The particles may be small, preferably less than 10 microns. The first population of particles may comprise an active metal dispersed on the first population of particles. The second population of particles may comprise a promoter dispersed on the second population of particles. The first and second populations of particles are mixed and formed into catalyst structures. The structures may be engineered for optimum performance in a partial oxidation reactor. The particles are mixed and formed in such a way that reactive species can spillover between the active metal and the promoter but that the active metal and the promoter will not interact with each other and cause catalyst deactivation. For purposes of this application, spillover is defined to be the process by which reactant molecules that are adsorbed by a first catalyst particle—and thus tend to have a higher concentration in a zone around that first catalyst particle-are influenced by a second promoter particle located within or near that zone but far enough from the first catalyst particle to avoid sintering. The zone may be within about 5 microns of the first catalyst particle, or it may be within about 1 micron or less.

In accordance with a preferred embodiment of the present invention, a synthesis gas catalyst is provided that is active for catalyzing the partial oxidation of light hydrocarbons. The catalyst comprises at least two distinct populations of particles. The first population may comprise a catalytic metal disposed on a support, and the second population may comprise a promoter disposed on a support. The first and second populations may be mixed to form the synthesis gas catalyst. In another embodiment, a catalyst is provided comprising first and second pluralities of particles. The first plurality of particles may comprise an active metal disposed on a support material, the active metal being selected to catalyze the partial oxidation of light hydrocarbons, and the second plurality of particles may comprise a promoter disposed on a support material. The first and second pluralities of particles may be mixed and disposed in close enough proximity to each other to allow reactive species to spillover between them.

In still another embodiment, a method is provided for preparing a synthesis gas catalyst. The method includes depositing an active metal on a support material and depositing a promoter on a support material. The support materials may then be mixed and disposed in such a way that reactive species can spillover between the active metal and the promoter.

In still another embodiment, a method is provided for making a synthesis gas. Light hydrocarbons and O₂ may be mixed and contacted with a catalyst at reaction conditions. The catalyst may comprise an active metal disposed on a plurality of support particles and a promoter disposed on a plurality of support particles. The pluralities of support particles may be mixed in such a way that reactive species can spillover between the active metal and the promoter.

In still another embodiment, the present catalysts are used in a method for making middle distillates from hydrocarbons. The hydrocarbons may be combined with O₂ and contacted with the present partial oxidation catalyst to form predominantly CO and H₂. The CO and H₂ may be fed to a Fischer-Tropsch unit where they are converted to middle distillates.

### BRIEF DESCRIPTION OF THE DRAWINGS

For a more detailed understanding of the preferred embodiments of the present invention, reference will be made to the accompanying Figures, wherein:

FIG. 1 is a graph of catalyst selectivity over time for the catalyst prepared as described in the Example.

### DETAILED DESCRIPTION OF PREFERRED EMBODIMENTS

Definitions

For purposes of the present disclosure, certain terms are intended to have the following meanings:

“Active metal” refers to any metal that is present on a catalyst that is active for catalyzing a particular reaction. Active metals may also be referred to as catalytic metals.

“Composite catalyst” refers to a catalyst that contains physically distinct components.

A “promoter” is one or more substances, such as a metal or rare-earth-containing compound that enhances any of the following catalytic properties: an active metal's catalytic activity, stability, and selectivity in a particular process, such as a CPOX process (e.g., increases conversion of the reactant and/or selectivity for the desired product). In some instances a particular promoter may additionally provide another function, such as stabilizing the catalyst support.

With respect to the catalytic partial oxidation of light hydrocarbons such as methane or natural gas to produce synthesis gas, references to “enhanced” or “improved catalytic performance” refer to enhancement or improvement of at least one of the following criteria: level of conversion of the reactants, productivity, selectivity for the desired products, physical and chemical stability of the catalyst, lifetime of the catalyst on stream, and resistance of the catalyst to deactivation.

A metal or metal oxide precursor compound is a chemical compound, such as, for example, a metal salt, that contains the atoms of the metal (e.g. a catalytic metal, a catalytic promoter, or a structural stabilizer metal) in an oxidation state that is not zero.

A “stabilized support” refers to a catalyst support that has been made more resistant to thermal shock or other thermally-induced deterioration such as sintering, and/or more resistant to alloying or other chemical reaction between the material of the support and the catalytic material or catalytic promoters that results in lowered catalyst performance in the catalytic partial oxidation of methane. Where appropriate and the context so indicates, the term “stabilized support” can also refer to a catalyst support that has been rendered more resistant to phase transition and/or to a support degrading or decomposing agent.

“Steaming treatment” or “steam calcination” refers to subjecting a given material (e.g., γ-alumina), within the confines of an autoclave or other suitable device, to an atmosphere comprising a saturated or unsaturated water vapor at conditions of elevated temperature and elevated water partial pressure, such that at least a portion of the material undergoes a phase change and/or a physical property of the material such as BET surface area, pore volume, or average pore diameter is significantly altered.

In a preferred embodiment, the present invention provides a composite catalyst that allows an active metal and a promoter to chemically interact without reacting with each other and causing catalyst deactivation. The invention provides for at least two distinct sets of catalyst support particles. The active metal may be dispersed on a first set, and the promoter may be dispersed on a second set. The catalyst may be composed by mixing the two sets and forming them into catalyst structures, such as trilobes or other extrudate forms. By forming such a catalyst, the negative effects of active metal-promoter interaction are substantially avoided.

Composite Catalysts Containing Active Metal Particles and Promoter Particles

An active metal, preferably Rh, and a promoter, preferably Sm or Sm oxide, may be impregnated onto separate batches of very small support particles. The support particles may be less than 10 microns in diameter. Preferably the support particles are less than 5 microns in diameter, and more preferably, the support particles are less than 1 micron in diameter. Particle size controls how closely the active metal and the promoter can interact. The goal is to have the active metal and the promoter in close enough proximity that intermediate reactive species, that are created during the partial oxidation reaction, can spillover from an active metal particle to a promoter particle or vice versa. However, the active metal and the promoter are preferably not too close, or the active metal and promoter may sinter or react with each other, resulting in catalyst deactivation.

A preferred procedure for making composite catalysts includes applying a thermally decomposable precursor compound of the active metal to a first aliquot of support particles and applying the promoter to a second aliquot of support particles using, for example, an incipient wetness impregnation technique. More than one active metal may be applied to a set of support particles, and more than one promoter may be applied to a set of support particles. After drying the wet supports, each group of loaded particles is then calcined. The calcination temperature is preferably not so high that it causes sintering or loss of surface area; however, it is preferable to calcine at a temperature that is about the same as the operating temperature of the CPOX process. The impregnated particles may then be physically mixed and formed into a desired catalyst unit shape that is suitable for loading into a short contact time syngas production reactor. In some embodiments, the impregnated particles are brought into close proximity by applying pressure to make a composite particle. The impregnated particles may be pressed together to form pellets. The pellets in turn may be subjected to a heat treatment such as calcination, then crushed and extruded or otherwise shaped into the desired unit catalyst shape. By forming the catalyst units (e.g., trilobes, granules, rings) from a well mixed composite of active particles and promoter particles, solid reaction between the active metal(s) and the promoter(s) is deterred, substantially decreased, or even prevented. As a result, the stability of the syngas catalyst is increased when it is employed at the high reaction temperatures that are typical of the catalytic partial oxidation reaction.

This general method may be modified, if desired, by using washcoating or any other well known technique for applying catalyst materials to a support instead of using the impregnation technique for applying the active metal and the promoter, or precursors thereof, onto their respective particulate support materials. Some examples of other well known techniques may include chemical vapor deposition, precipitation, or plasma sputtering.

Some suitable active metals include Rh, Pd, Ru, Os, Ir, Pt, Co, Ni, Re, and some suitable promoters include La, Ce, Pr, Nd, Pm, Sm, Eu, Gd, Th, Dy, Ho, Er, Tm, Yb, Lu, and oxides thereof. A highly preferred combination is Rh and Sm, especially those containing about 0.05-25 wt % Rh and about 0.1-10 wt % Sm supported on separate particles that are mixed and formed into composite units comprising both types of particles. Percentages of active metals and promoters are based on the weight of the final product.

The present composite catalysts are preferably in the form of composite materials containing distinct or discrete structures or units, such as granules, beads, pills, pellets, cylinders, trilobes, extrudates, spheres or other rounded shapes or manufactured configurations that provide satisfactory engineering performance when used to form a fixed catalyst bed or catalyst device in a short contact time CPOX reactor. Satisfactory engineering performance means that the configuration provides a pressure drop that is not excessive and a structure that is strong enough to withstand high space velocities and the stresses of catalyst loading, transportation, or operation. Alternatively, the catalyst structures may be in the form of irregularly shaped particles. The supported catalyst granules or spheres may be used in various sizes, but preferably range in size from 50 microns to 6 millimeters (mm) in diameter (i.e., about 120 mesh). Preferably at least a majority (i.e., >50%) of the particles or distinct structures have a maximum characteristic length (i.e., longest dimension) of less than six millimeters, more preferably less than three millimeters. A preferred particle size range is about 180 microns (80 mesh) to about 6 millimeters (1/4 inch), more preferably about 300 microns to about 3 millimeters. The term “mesh” refers to a standard sieve opening in a screen through which the material will pass, as described in the Tyler Standard Screen Scale (C. J. Geankoplis, TRANSPORT PROCESSES AND UNIT OPERATIONS, Allyn and Bacon, Inc., Boston, Mass., p. 837), incorporated herein by reference.

Catalytic supports for use herein can be made from any suitable refractory support material and/or made from a boehmite or pseudo-boehmite material. Different populations of particles may contain the same or different support materials. The primary criterion for a support material is that it be capable of being formed into a physical structure that provides sufficient mechanical strength and catalyst bed porosity to function under operating conditions of high pressure and high flow rate of process gases. The support may therefore be modified, stabilized, or treated to confer better mechanical integrity and/or chemical stability under operating conditions. Preferred support materials are boehmite-derived material and refractory oxides including alumina, zirconia, magnesia, titania, ceria, thoria, boria, cordierite, mullite, silica, and combinations thereof. Some other suitable support materials are niobia, vanadia, nitrides, and carbides.

Additionally, the structurally stabilized supports disclosed in co-owned U.S. Patent Application No. 60/425,383 may be used. Those supports preferably contain a refractory oxide and a structural promoter or stabilizer comprising an element from Groups 1-14 of the Periodic Table of Elements (New IUPAC notation), such as B, Mg, Si, Ca, Ti, Cr, Mn, Fe, Co, Ni, Cu, Zn, Ga, Sr, Zr, Ba, Se and the rare earth elements from Sc through Lu, especially Si, Mg, Ca, Mn, Co, Fe, Zr, Y, La, Ce, Pr, Nd, and Sm. The formation of a solid solution or crystal lattice stabilized composition is believed to provide a more robust catalyst that deters loss of catalytic and/or promoter metal by solid reaction with the support material. Stabilized supports disclosed in co-owned provisional U.S. Patent Application Nos. 60/419,073 and 60/419,003 (incorporated herein by reference in their entirety) may also be used. These supports are made using a boehmite or pseudo-boehmite material. The boehmite or pseudo-boehmite material can be contacted with a structural promoter such as those described above, and is exposed to a heat treatment such as calcination. The disclosures of these applications are incorporated by reference in their entirety.

Alumina may be structurally stabilized by first subjecting γ-alumina to heat treatment in the presence of steam (“steam treatment” or “steam calcination”) to convert the γ-alumina to boehmite or to primarily boehmite plus a mixture of lesser amounts of transition aluminas, or to pseudoboehmite alumina, depending on the selected steam treatment conditions. The γ-alumina starting material may be any suitable commercially available γ-Al₂O₃ product such as is available from well-known suppliers (e.g., Sasol North America Inc., Houston, Tex.; GRACE Davison, Columbia, Md.; Engelhard, Beachwood, Ohio; Alcoa, Pittsburgh, Pa.; Saint-Gobain N or Pro, Akron, Ohio; Süd-Chemie, Louisville, Ky.), or it may be made by methods known to those of skill in the art. The amount of added structural promoter is preferably sufficient to convert the selected support material into a form that is resistant to phase change under CPOX reaction conditions and at the same time is not so great that it causes the desired surface area characteristics of the chosen support to diminish appreciably, for example, due to sintering of the stabilizer during calcination. The amount of structural stabilizer applied is preferably in the range of about 0.1-10% by weight (wt % of the metal component per total weight of support). Depending on the desired characteristics of a particular catalyst, in some instances the amount of stabilizer is more preferably 1-10 wt %, and in certain instances still more preferably 2-7 wt %. After this optional steam treatment, the treated alumina-based support is dried and then impregnated or otherwise loaded using standard techniques with one or more structural stabilizers. Alternately, the alumina may be first impregnated and then steam-treated to form the boehmite. The combined structural promoter and steam-treated alumina can then be calcined at a temperature that is in the expected operating temperature range of the CPOX process (i.e., about 600-1600° C., preferably 800-1200° C.) to promote solid reactions (i.e., formation of a solid solution) between at least a major portion of the support and the structural promoter, preferably resulting in the formation of a crystal lattice-stabilized aluminum oxide structure.

The preferred set of conditions for steaming of the γ-Al₂O₃ includes heating at a temperature in the range of 150-500° C., more preferably 180-300° C., and still more preferably 200-250° C., and at a water vapor partial pressure in the range of 100-4,000 kPa (1-40 bar), more preferably 400-2,000 kPa (4-20 bar), and still more preferably 1,000-2,000 kPa (10-20 bar). This steam calcination treatment is preferably carried out over a time interval in the range of 1-10 hours, preferably 2-4 hours. Under these conditions the YAl₂O₃ is preferably completely transformed to a boehmite alumina, or at least to primarily boehmite with lesser amounts of pseudoboehmite and/or transition aluminas, to yield the final support after drying or subsequent calcination. The support may then be sieved or ground and sieved to preferably less than 10 microns, more preferably less than 5 microns, and most preferably less than 1 micron.

Process of Producing Syngas

A process for producing synthesis gas employs a catalyst as previously described that is active in catalyzing the efficient conversion of reactive species comprising at least one gaseous hydrocarbon (such as methane or natural gas) and molecular oxygen to primarily CO and H₂ by a net catalytic partial oxidation (CPOX) reaction. Suitable catalysts include any of the composite catalysts prepared as described above. A preferred catalyst comprises about 0.05-25 wt % rhodium and about 0.1-10 wt % Sm supported separately on a support.

Preferably employing a very fast contact (i.e., millisecond range)/fast quench (i.e., less than one second) reactor assembly, a feed stream comprising a hydrocarbon feedstock and an oxygen-containing gas may be mixed together and contacted with the catalyst as described below. One suitable reaction regime is a fixed bed reaction regime, in which the catalyst is retained within a reaction zone in a fixed arrangement. The feed stream may be contacted with the catalyst in a reaction zone maintained at autothermal net partial oxidation-promoting conditions effective to produce an effluent stream comprising primarily carbon monoxide and hydrogen. The hydrocarbon feedstock is preferably a light hydrocarbon such as any gaseous hydrocarbon having a low boiling point-e.g., methane, natural gas, associated gas, or other sources of light hydrocarbons having from 1 to 5 carbon atoms. The hydrocarbon feedstock may be a gas arising from naturally occurring reserves of methane, which contain carbon dioxide. Preferably, the feed comprises at least about 50% by volume methane, more preferably at least 80% by volume, and most preferably at least 90% by volume methane.

The hydrocarbon feedstock is in the gaseous phase when contacting the catalyst. The hydrocarbon feedstock may be contacted with the catalyst as a mixture with an O₂-containing gas, preferably substantially pure oxygen; however, the O₂-containing gas may be air or a mixture of O₂ with other materials, such as nitrogen or other inerts. The hydrocarbon feedstock may be contacted with the catalyst as a mixture containing steam and/or CO₂ along with a light hydrocarbon gas, as sometimes occurs in natural gas deposits.

The methane-containing feed and the O₂-containing gas may be mixed in such amounts to give a carbon (i.e., carbon in methane) to oxygen (i.e., molecular oxygen) ratio from about 1.5:1 to about 3.3:1, more preferably, from about 1.7:1 to about 2.1:1. The stoichiometric molar ratio of about 2:1 (CH₄:O₂) is especially desirable in obtaining the net partial oxidation reaction products ratio of 2:1H₂:CO. In some situations, such as when the methane-containing feed is a naturally occurring methane reserve, carbon dioxide may also be present in the methane-containing feed without detrimentally affecting the process. The process is operated at atmospheric or superatmospheric pressures, the latter being preferred. The pressures may be from about 100 kPa to about 32,000 kPa (about 1-320 atm), preferably from about 200 kPa to 10,000 kPa (about 2-100 atm).

The process may be operated at a temperature in the range of about 600° C. to about 2,000° C., preferably about 600° C. to about 1,600° C. The hydrocarbon feedstock and the oxygen-containing gas may be pre-heated before contacting the catalyst. Preferably, the feedstock is preheated to about 30-750° C., more preferably between about 200 and about 500° C.

The hydrocarbon feedstock and the oxygen-containing gas may be passed over the catalyst at any of a variety of space velocities. Space velocities for the process, stated as gas hourly space velocity (GHSV), are in the range of about 20,000 to about 100,000,000 hr⁻¹, preferably 50,000-25,000,000 hr⁻¹, more preferably about 100,000-10,000,000 hr⁻¹. Under these operating conditions a flow rate of reactant gases may be maintained sufficient to ensure a residence time of no more than 200 milliseconds, preferably less than 50 milliseconds, and more preferably less than 20 milliseconds, with respect to each portion of reactant gas in contact with the catalyst system. A contact time of 10 milliseconds or less is highly preferred.

The product gas mixture emerging from the reactor is harvested and may be routed directly into any of a variety of applications. One such application for the CO and H₂ product stream is for producing higher molecular weight hydrocarbon compounds using Fischer-Tropsch technology. The synthesis gas may be routed to a Fischer-Tropsch process where it may be converted to hydrocarbons in the middle distillate boiling range, such as kerosene and diesel fuel; hydrocarbons in the gasoline boiling range; hydrocarbon waxes; and/or lube oils. Another application is the use of syngas to produce methanol. Alternatively, the syngas product can serve as a source of H₂ (e.g., for fuel cells), in which case catalysts that provide enhanced selectivity for H₂ product may be selected, and process variables can be adjusted, if desired, such that the syngas is rich in hydrogen and has a H₂:CO ratio greater than 2:1. Fuel cells are chemical power sources in which electrical power is generated in a chemical reaction. The most common fuel cell is based on the chemical reaction between a reducing agent such as hydrogen and an oxidizing agent such as oxygen.

The syngas produced by the syngas process is preferably converted to hydrocarbon via a hydrocarbon synthesis process, such as, by way of example only, the Fischer-Tropsch synthesis. The literature is replete with particular embodiments of Fischer-Tropsch reactors and Fischer-Tropsch catalyst compositions. An example of Fischer-Tropsch synthesis is disclosed in U.S. Pat. No. 6,365,544 to Herron et al., incorporated herein by reference in its entirety.

Typically, the hydrocarbon synthesis reactor contains a catalyst which comprises one or more metals such as metals from Groups 8, 9, and 10 of the Periodic Table (new IUPAC notation) such as iron, nickel, ruthenium, or cobalt and one or more promoter metals from Groups 1, 2, 7, 8, 9, 10, 11, and 13 of the Periodic Table, such as rhenium, ruthenium, silver, platinum, palladium, boron, copper, manganese, sodium, potassium, and combinations thereof, all of which may be supported on an inorganic oxide such as those comprising alumina, zirconia, titania, silica, boria, or combinations thereof. The inorganic oxide support may be modified or stabilized by the addition of at least one structural promoter (or stabilizer) so as to convey hydrothermal resistance and/or attrition resistance to the support and catalyst made therefrom. In the hydrocarbon synthesis reactor, the syngas stream reacts to form a product stream, which generally comprises hydrocarbons with 5 carbon atoms or more (C₅₊). The slate or distribution of product stream may be manipulated by changing the conditions of the hydrocarbon synthesis reactor.

It is preferred that the molar ratio of hydrogen to carbon monoxide in the syngas feed to the Fischer-Tropsch reactor be greater than 0.5:1 (e.g., from about 0.67 to about 2.5). Preferably, when cobalt, iron, nickel, and/or ruthenium catalysts are used, the feed gas stream contains hydrogen and carbon monoxide in a molar ratio of about 1.4:1 to about 2.3:1. The syngas feed may also contain carbon dioxide and should contain only a low concentration of compounds or elements that have a deleterious effect on the catalyst, such as poisons. For example, the syngas feed may need to be pretreated to ensure that it contains low concentrations of sulfur or nitrogen compounds such as hydrogen sulfide, hydrogen cyanide, ammonia and carbonyl sulfides.

The feed gas is contacted with the catalyst in a reaction zone. Mechanical arrangements of conventional design may be employed as the reaction zone including, for example, fixed bed, fluidized bed, slurry bubble column or ebulliating bed reactors, among others. Accordingly, the preferred size and physical form of the catalyst particles may vary depending on the reactor in which they are to be used. Particular embodiments of the Fischer-Tropsch reactors and modes of operations are disclosed in co-owned published patent applications U.S. 2003-0027875 A1 and U.S. 2003-0114543 A1, wherein each is incorporated herein by reference in its entirety.

The hydrocarbon synthesis process is typically run in a continuous mode. In this mode, the gas hourly space velocity through the reaction zone typically may range from about 50 to about 10,000 hr⁻¹, preferably from about 300 hr⁻¹ to about 2,000 hr⁻¹, wherein the gas hourly space velocity is defined as the volume of reactants (at standard conditions of pressure (101 kPa) and temperature (0° C.)) per time per reaction zone volume. The reaction zone volume is defined by the portion of the reaction vessel volume where the reaction takes place and which is occupied by a gaseous phase comprising reactants, products, and/or inerts; a liquid phase comprising liquid/wax products and/or other liquids; and a solid phase comprising catalyst. The reaction zone temperature is typically in the range from about 160° C. to about 300° C. Preferably, the reaction zone is operated at conversion promoting conditions at temperatures from about 190° C. to about 260° C.; more preferably from about 205° C. to about 230° C. The reaction zone pressure is typically in the range of about 80 psia (552 kPa) to about 1000 psia (6895 kPa), more preferably from 80 psia (552 kPa) to about 800 psia (5515 kPa), and still more preferably, from about 140 psia (965 kPa) to about 750 psia (5170 kPa). Most preferably, the reaction zone pressure is from about 250 psia (1720 kPa) to about 650 psia (4480 kPa).

The liquid products generated from the hydrocarbon synthesis process may be further processed by hydrocracking or hydrotreating as disclosed in U.S. patent application Ser. No. 10/382,339, which is incorporated herein by reference in its entirety.

### EXAMPLE

The invention having been generally described, the following example is given as a particular embodiment of the invention and to demonstrate the practice and advantages thereof. It is understood that the example is given by way of illustration and is not intended to limit the specification or the claims to follow in any manner.

A sample catalyst according to an embodiment of the present invention was prepared according to the following description. 1.89 g Sm(NO₃)₃.6H₂O (Aldrich) was dissolved in sufficient water to form an aqueous solution. The resulting solution was applied to 8 g of alpha alumina powder (Alcoa) for wet impregnation, then allowed to dry using a rotary evaporator. The impregnated powder was calcined in air according to the following schedule: 5° C./minute ramp to 325° C., hold at 325° C. for 1 hour, 5° C./minute ramp to 700° C., hold at 700° C. for 2 hours, cool down to room temperature. The same impregnation, drying, and calcination steps were followed to apply Rh onto alumina powder with 1.19 g RhCl₃.xH₂O and 8 g of the same type of alpha alumina powder used. The calcined powders were mixed together and pressed into pellets. The pellets were then calcined in air at 700° C. for 2 hours. The resulting pellets were crushed into 30-50 mesh granules. The granules were reduced at 500° C. for 3 hours under a stream of 300 mL/min H₂ and 300 mL/min N₂.

Test Procedure for Evaluating Catalyst Performance

The present catalysts can be used to make synthesis gas. Representative catalysts were evaluated for their ability to catalyze the partial oxidation reaction in a conventional flow apparatus using a quartz reactor with a length of 12 inches, an outside diameter of 19 mm and an inside diameter of 13 mm. Ceramic foam pieces of 99% Al₂O₃ (12 mm outside diameter×5 mm thick, with 45 pores per linear inch) were placed before and after the catalyst as radiation shields. The catalyst bed was approximately 12 mm in diameter×10 cm in height. The inlet radiation shield also aided in uniform distribution of the feed gases. An Inconel-sheathed, single point K-type (Chromel/Alumel) thermocouple was placed axially inside the reactor, touching the top (inlet) face of the radiation shield. A high temperature S-Type (Pt/Pt 10% Rh) bare-wire thermocouple was positioned axially touching the bottom face of the catalyst, and was used to indicate the reaction temperature. The catalyst and the two radiation shields were tightly sealed against the inside walls of the quartz reactor by wrapping the shields radially with a high purity (99.5%) alumina paper. A 600-watt band heater set at 90% electrical output was placed around the quartz tube, providing heat to light off the reaction and preheat the feed gases. The bottom of the band heater corresponded to the top of the upper radiation shield.

In addition to the thermocouples placed above and below the catalyst, the reactor also contained two axially positioned, triple-point thermocouples, one before and another after the catalyst. These triple-point thermocouples were used to determine the temperature profiles of the reactants and products that were subjected to preheating and quenching, respectively.

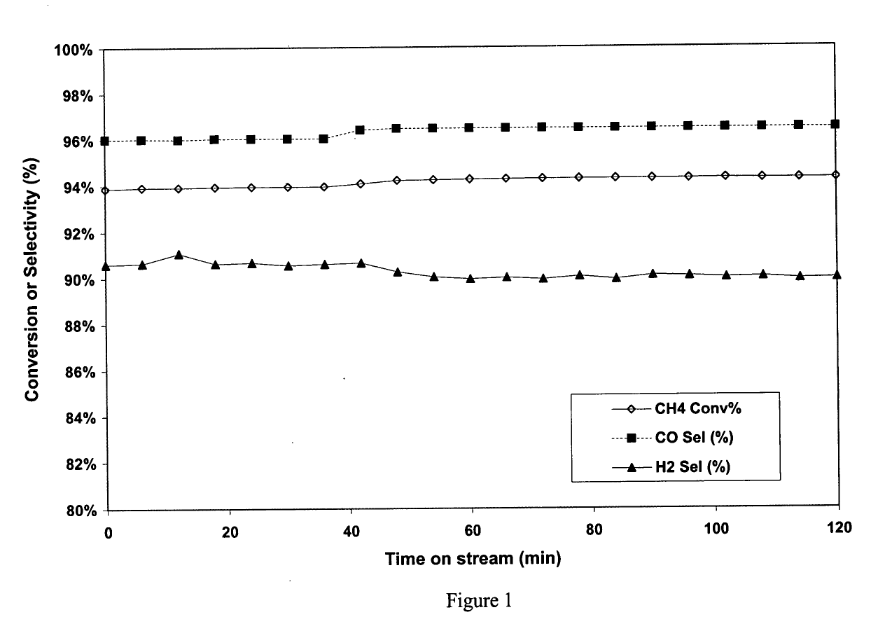

The runs were conducted at a volumetric oxygen to methane ratio of 0.55, a preheat temperature of 300° C., and a combined flow rate of 3,500 cc/min (3.5 standard liters per minute (SLPM)), corresponding to a gas hourly space velocity (GHSV) of about 1.7×10⁵ hr⁻¹, or at a flow rate of 5,000 cc/min (about 2.4×10⁵ hr⁻¹ GHSV), and at a pressure of 5 psig (136 kPa). The reactor effluent was analyzed using a gas chromatograph equipped with a thermal conductivity detector. The data reported in Table 1 and FIG. 1 were obtained after approximately 3.5 hours on stream at the specified conditions.

TABLE 1

| Time | | | | H2 | |
|---|---|---|---|---|---|
| (min) | CH4 C nv. % | O2 c nv % | CO sel. % | selec. % | CO2 sel. % |
| 0 | 93.9% | 100.0% | 96.0% | 90.6% | 4.0% |
| 6 | 93.9% | 100.0% | 96.0% | 90.6% | 4.0% |
| 12 | 93.9% | 100.0% | 96.0% | 91.1% | 4.0% |
| 18 | 93.9% | 100.0% | 96.0% | 90.6% | 4.0% |
| 24 | 93.9% | 100.0% | 96.0% | 90.7% | 4.0% |
| 30 | 93.9% | 100.0% | 96.0% | 90.5% | 4.0% |
| 36 | 94.0% | 100.0% | 96.0% | 90.6% | 4.0% |
| 42 | 94.1% | 100.0% | 96.4% | 90.7% | 3.6% |
| 48 | 94.2% | 100.0% | 96.5% | 90.3% | 3.5% |
| 54 | 94.2% | 100.0% | 96.5% | 90.0% | 3.5% |
| 60 | 94.2% | 100.0% | 96.5% | 89.9% | 3.5% |
| 66 | 94.3% | 100.0% | 96.5% | 90.0% | 3.5% |
| 72 | 94.3% | 100.0% | 96.5% | 89.9% | 3.5% |
| 78 | 94.3% | 100.0% | 96.5% | 90.1% | 3.5% |
| 84 | 94.3% | 100.0% | 96.5% | 89.9% | 3.5% |
| 90 | 94.3% | 100.0% | 96.5% | 90.1% | 3.5% |
| 96 | 94.3% | 100.0% | 96.5% | 90.1% | 3.5% |
| 102 | 94.3% | 100.0% | 96.5% | 90.0% | 3.5% |
| 108 | 94.3% | 100.0% | 96.5% | 90.0% | 3.5% |
| 114 | 94.3% | 100.0% | 96.5% | 89.9% | 3.5% |
| 120 | 94.28% | 100.00% | 96.48% | 89.97% | 3.52% |

While the preferred embodiments of the invention and an example have been shown and described, modifications thereof can be made by one skilled in the art without departing from the sprint and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all patents, patent applications and publications cited herein are incorporated by reference. The discussion of certain references in the Description of Related Art, above, is not an admission that they are prior art to the present invention, especially any references that may have a publication date after the priority date of this application.

1. A composite catalyst for producing synthesis gas, said catalyst comprising a mixture of at least two distinct populations of particles and said catalyst having activity for converting reactive species comprising at least one gaseous hydrocarbon and oxygen via partial oxidation to form carbon monoxide and hydrogen,
wherein a first of said populations comprises a first plurality of particles comprising at least one catalytic metal disposed on a first support, and
wherein a second of said populations comprises a second plurality of particles comprising at least one promoter disposed on a second support.

2. The catalyst of claim 1 wherein said catalytic metal is chosen from the group consisting of Rh, Pd, Ru, Os, Ir, Pt, Co, Ni, Re, and oxides thereof.

3. The catalyst of claim 1 wherein said at least one promoter is chosen from the group consisting of La, Ce, Pr, Nd, Pm, Sm, Eu, Gd, Th, Dy, Ho, Er, Tm, Yb, Lu, and oxides thereof.

4. The catalyst of claim 1 wherein said catalytic metal comprises Rh and said promoter comprises Sm.

5. The catalyst of claim 4 comprising 0.05-25 wt % Rh and 0.1-10 wt % Sm (based on total weight of the catalyst).

6. The catalyst of claim 1 wherein said first and said second supports are each made using at least one material chosen from the group consisting of boehmite, pseudo-boehmite, alumina, zirconia, magnesia, titania, ceria, thoria, boria, cordierite, mullite, silica, niobia, vanadia, nitrides, and carbides.

7. The catalyst of claim 1 wherein said first and said second supports each comprise at least one material chosen from the group consisting of alumina, zirconia, magnesia, titania, ceria, thoria, boria, cordierite, mullite, silica, niobia, vanadia, nitrides, and carbides.

8. The catalyst of claim 7 wherein at least one of said first and said second supports further comprises at least one structural stabilizer selected from the group consisting of B, Mg, Si, Ca, Ti, Cr, Mn, Fe, Co, Ni, Cu, Zn, Ga, Se, Sr, Zr, Ba, Sc, Y, La, Ce, Nd, Pr, and Sm.

9. The catalyst of claim 1 wherein at least one of said first and said second supports includes a refractory material selected from the group consisting of aluminum oxide, zirconium oxide, titanium oxide, silicon oxide, and combinations thereof and a structural stabilizer selected from the group consisting of B, Mg, Si, Ca, Ti, Cr, Mn, Fe, Co, Ni, Cu, Zn, Ga, Sr, Zr, Ba, Se, Sc, Y, La, Ce, Nd, Pr, Sm, and combinations thereof.

10. The catalyst of claim 1 wherein a majority of each of said first and said second pluralities of particles have a diameter of less than 5 microns.

11. The catalyst of claim 10 wherein said majority of each of said first and said second pluralities of particles have a diameter of less than 1 micron.

12. The catalyst of claim 1 wherein said first and said second populations are mixed such that the reactive species can spillover between said at least one catalytic metal and said at least one promoter.

13. The catalyst of claim 1 wherein said catalyst comprises a plurality of distinct structures, each said structure having a maximum characteristic length of less than 6 millimeters.

14. The catalyst of claim 13 wherein each said structure has a maximum characteristic length of less than 3 millimeters.

15. The catalyst of claim 14 wherein the maximum characteristic length of each said structure is in the range of about 300 microns to about 3 millimeters.

16. The catalyst of claim 1 wherein said first and said second supports comprise the same support material.

17. The catalyst of claim 10 where the distinct structures are brought into close proximity by applying pressure to make a composite particle.

18. A catalyst comprising:
a first plurality of particles comprising a first active metal disposed on a first support material, said first active metal selected to promote the conversion of reactive species comprising oxygen and at least one light hydrocarbon via partial oxidation; and
a second plurality of particles comprising a first promoter disposed on a second support material, wherein said first and said second pluralities of particles are mixed and disposed in close enough proximity to each other to allow said reactive species to spillover between them.

19. A method for making a synthesis gas catalyst suitable to promote the conversion of reactive species comprising oxygen and at least one light hydrocarbon, the method comprising the steps of:
(a) depositing a first active metal on a first support material;
(b) depositing a first promoter on a second support material;
(c) mixing said first and said second support materials in such a way that said reactive species can spillover between said first active metal and said first promoter when said catalyst is in service and under reaction conditions.

20. The method of claim 19 wherein said first active metal comprises a metal selected from the group consisting of Rh, Pd, Ru, Os, Ir, Pt, Co, Ni, Re, and oxides thereof.

21. The method of claim 20 further comprising the step of:
(d) before step (c), depositing a second active metal on said first support material, said second active metal being selected from the group consisting of Rh, Pd, Ru, Os, Ir, Pt, Co, Ni, Re, and oxides thereof.

22. The method of claim 19 wherein said first and said second support materials each comprise a distinct plurality of particles.

23. The method of claim 22 wherein a majority of said pluralities of particles have a diameter less than 5 microns.

24. The method of claim 23 wherein a majority of said pluralities of particles have a diameter less than 1 micron.

25. The method of claim 19 wherein said first promoter is chosen from the group consisting of La, Ce, Pr, Nd, Pm, Sm, Eu, Gd, Th, Dy, Ho, Er, Tm, Yb, Lu, and oxides thereof.

26. The method of claim 25 further comprising the step of:
(d) before step (c), depositing a second promoter on said second support material, said second promoter being chosen from the group consisting of La, Ce, Pr, Nd, Pm, Sm, Eu, Gd, Th, Dy, Ho, Er, Tm, Yb, Lu, and oxides thereof.

27. The method of claim 19 wherein said first and said second support materials are each made using at least one material chosen from the group consisting of boehmite, pseudo-boehmite, alumina, zirconia, magnesia, titania, ceria, thoria, boria, cordierite, mullite, silica, niobia, vanadia, nitrides, and carbides.

28. The method of claim 19 wherein said first and said second support materials each comprise at least one material chosen from the group consisting of alumina, zirconia, magnesia, titania, ceria, thoria, boria, cordierite, mullite, silica, niobia, vanadia, nitrides, and carbides.

29. The method of claim 28 wherein at least one of said first and said second supports further comprises at least one structural stabilizer selected from the group consisting of B, Mg, Si, Ca, Ti, Cr, Mn, Fe, Co, Ni, Cu, Zn, Ga, Se, Sr, Zr, Ba, Sc, Y, La, Ce, Nd, Pr, and Sm.

30. The method of claim 19 wherein at least one of said first and said second supports includes a refractory material selected from the group consisting of aluminum oxide, zirconium oxide, titanium oxide, silicon oxide, and combinations thereof and a structural stabilizer selected from the group consisting of B, Mg, Si, Ca, Ti, Cr, Mn, Fe, Co, Ni, Cu, Zn, Ga, Sr, Zr, Ba, Se, Sc, Y, La, Ce, Nd, Pr, Sm, and combinations thereof.

31. The method of claim 28 wherein said first and said second support materials comprise the same material.

32. The method of claim 19 wherein said first active metal comprises Rh and said first promoter comprises Sm.

33. A method for making synthesis gas comprising the steps of:
(a) contacting a first reactive species comprising oxygen and a second reactive species comprising at least one light hydrocarbon with a catalyst at reaction conditions, said catalyst comprising:
a first active metal disposed on a first plurality of support particles; and
a first promoter disposed on a second plurality of support particles, said first and said second pluralities of support particles being mixed in such a way that said first and said second reactive species can spillover between said first active metal and said first promoter; and
(b) converting a portion of said second reactive species to form a product comprising hydrogen and carbon monoxide.

34. The method of claim 33 wherein said first active metal comprises a metal selected from the group consisting of Rh, Pd, Ru, Os, Ir, Pt, Co, Ni, Re, and oxides thereof.

35. The method of claim 34 wherein said catalyst further comprises
a second active metal disposed on said first plurality of support particles said second active metal being selected from the group consisting of Rh, Pd, Ru, Os, Ir, Pt, Co, Ni, Re, and oxides thereof.

36. The method of claim 33 wherein a majority of said first and said second pluralities of support particles have a diameter less than 5 microns.

37. The method of claim 36 wherein a majority of said first and said second pluralities of support particles have a diameter less than 1 micron.

38. The method of claim 33 wherein said first promoter is chosen from the group consisting of La, Ce, Pr, Nd, Pm, Sm, Eu, Gd, Th, Dy, Ho, Er, Tm, Yb, Lu, and oxides thereof.

39. The method of claim 38 wherein said catalyst further comprises
a second promoter disposed on said second plurality of support particles, said second promoter being chosen from the group consisting of La, Ce, Pr, Nd, Pm, Sm, Eu, Gd, Th, Dy, Ho, Er, Tm, Yb, Lu, and oxides thereof.

40. The method of claim 33 wherein said first and said second pluralities of support particles are each made using at least one refractory material chosen from the group consisting of boehmite, pseudo-boehmite, alumina, zirconia, magnesia, titania, ceria, thoria, boria, cordierite, mullite, silica, niobia, vanadia, nitrides, and carbides.

41. The method of claim 33 wherein said first and said second pluralities of support particles each comprise at least one refractory material chosen from the group consisting of alumina, zirconia, magnesia, titania, ceria, thoria, boria, cordierite, mullite, silica, niobia, vanadia, nitrides, and carbides.

42. The method of claim 41 wherein at least one of said first and said second supports further comprises at least one structural stabilizer selected from the group consisting of B, Mg, Si, Ca, Ti, Cr, Mn, Fe, Co, Ni, Cu, Zn, Ga, Se, Sr, Zr, Ba, Sc, Y, La, Ce, Nd, Pr, and Sm.

43. The method of claim 33 wherein at least one of said first and said second supports includes a refractory material selected from the group consisting of aluminum oxide, zirconium oxide, titanium oxide, silicon oxide, and combinations thereof and a structural stabilizer selected from the group consisting of B, Mg, Si, Ca, Ti, Cr, Mn, Fe, Co, Ni, Cu, Zn, Ga, Sr, Zr, Ba, Se, Sc, Y, La, Ce, Nd, Pr, Sm, and combinations thereof.

44. The method of claim 41 wherein said first and said second pluralities of support particles have at least one material in common.

45. The method of claim 33 wherein said first active metal comprises Rh and said first promoter comprises Sm.

46. A method for making middle distillates from at least one light hydrocarbon comprising the steps of:
(a) contacting a first reactant comprising oxygen and a second reactant comprising at least one light hydrocarbon with a catalyst at reaction conditions, said catalyst comprising:
a first active metal disposed on a first plurality of support particles; and
a first promoter disposed on a second plurality of support particles, said first and said second pluralities of support particles being mixed in such a way that said reactants can spillover between said first active metal and said first promoter;
(b) converting at least a portion of said first and second reactants with said catalyst to form a synthesis gas comprising predominantly CO and H₂;
(c) feeding said synthesis gas to a Fischer-Tropsch process; and
(d) converting said synthesis gas into a hydrocarbon product comprising middle distillates.

47. The method of claim 46 wherein said first active metal comprises a metal selected from the group consisting of Rh, Pd, Ru, Os, Ir, Pt, Co, Ni, Re, and oxides thereof.

48. The method of claim 46 wherein said first promoter is chosen from the group consisting of La, Ce, Pr, Nd, Pm, Sm, Eu, Gd, Th, Dy, Ho, Er, Tm, Yb, Lu, and oxides thereof.
